(19) United States
(12) Patent Application Publication
(10) Pub. No.: US 2026/0223113 A1
(43) Pub. Date: Jul. 30, 2026

(54) INDICATION FOR UNUSED TRANSMISSION OCCASIONS FOR UPLINK CANCELLATION

(71) Applicant: Lenovo (Singapore) Pte. Limited, Singapore (SG)

(72) Inventors: Hossein Bagheri, Urbana, IL (US); Vijay Nangia, Woodridge, IL (US); Joachim Löhr, Wiesbaden (DE)

(73) Assignee: Lenovo (Singapore) Pte. Limited, Singapore (SG)

(21) Appl. No.: 19/151,847

(22) PCT Filed: Jan. 29, 2024
(86) PCT No.: PCT/IB2024/050818

§ 371 Date: Jul. 29, 2025

Related U.S. Application Data
(60) Provisional application No. 63/482,095, filed on Jan. 30, 2023.

(51) Int. Cl. H04W 72/20; H04W 72/115

(52) U.S. Cl. CPC H04W 72/20; H04W 72/115

(57) ABSTRACT

Various aspects of the present disclosure relate to methods, apparatuses, and systems that support indication for unused transmission occasions for uplink cancellation. For instance, implementations provide for ways for enabling user equipment (UE) and network entities (e.g., gNB) to be synchronized regarding unused configured grant (CG) transmission occasions (TO) within a determined duration of time. In implementations, for example, regrouping of CG TO for unused TO provides unused CG TO group indications based on dynamically cancelled TO. Further, and based at least in part on a time gap between dynamic UE cancellation and uplink control information (UCI), a UE can determine unused CG TO and indicate them to a network entity, and can determine whether to transmit a TB of a canceled CG TO in another CG TO that has been indicated as unused.

### RELATED APPLICATION

This application claims priority to U.S. Provisional Application Ser. No. 63/482,095 filed Jan. 30, 2022, entitled “INDICATION FOR UNUSED TRANSMISSION OCCASIONS FOR UPLINK CANCELLATION,” the disclosure of which is incorporated by reference herein in its entirety.

### TECHNICAL FIELD

The present disclosure relates to wireless communications, and more specifically to configuration of transmission resources in wireless communications.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, sub-slots, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems provide ways for providing transmission resources for a UE to transmit data, e.g., for uplink (UL) transmission. For instance, a network can allocate pre-configured resources also known as configured grant (CG) resources to a UE for UL transmission. A UE, however, may not utilize at least some CG resources, which may result in inefficient use of UL resources.

### SUMMARY

The present disclosure relates to methods, apparatuses, and systems that support indication for unused transmission occasions when uplink cancellation cancels some of transmission occasions. For instance, implementations provide for ways for enabling UEs and network entities (e.g., gNB) to be synchronized regarding unused CG transmission occasions (TO) within a determined duration of time. In implementations, for example, regrouping of CG TOs for unused TO provides unused CG TO group indications based on dynamically cancelled TO. Further, and based at least in part on a time gap between dynamic UL cancellation and uplink control information (UCI), a UE can determine unused CG TO and indicate them to a network entity, and can determine whether to transmit a transport block (TB) of a canceled CG TO in another CG TO that has been indicated as unused.

By utilizing the described techniques, a UE and a network entity can be mutually aware of unused CG TO, which can enable the UE to efficiently utilize available CG TO and the network entity to schedule transmissions (e.g., by the UE or other UEs) on available (e.g. unused) CG resources. This can enable more efficient utilization and scheduling of available CG resources.

Some implementations of the methods and apparatuses described herein may further include receiving, at an apparatus, signaling canceling a subset of transmission occasions of a set of transmission occasions of a CG configuration; grouping transmission occasions of the set of transmission occasions based on a gap between the received signaling and a reference time associated with the CG configuration, including one or more of: grouping the transmission occasions of the set of transmission occasions according to a first grouping rule based at least in part on the gap being not larger than a gap threshold; or grouping the transmission occasions of the set of transmission occasions according to a second grouping rule based at least in part on the gap being larger than the gap threshold; and transmitting an indication of one or more groups of the transmission occasions that include at least one unused transmission occasion.

Some implementations of the methods and apparatuses described herein may further include: the set of transmission occasions are confined within a duration of time; further including receiving a configuration to configure the apparatus to indicate unused transmission occasions of the CG configuration within the duration of time; grouping the transmission occasions of the set of transmission occasions according to the first grouping rule includes mapping the transmission occasions to different groups; a number of transmission occasions in one or more groups associated with the second grouping rule is smaller than a number of transmission occasions in one or more groups associated with the first grouping rule; transmitting the indication of one or more groups of the transmission occasions that include at least one unused transmission occasion includes transmitting the indication via UCI within a duration of time.

Some implementations of the methods and apparatuses described herein may further include: the gap includes a second duration of time based at least in part on a number of symbols between a last symbol of a control resource set (CORESET) including the signaling and a first symbol of the UCI; further including determining a duration of the gap in the number of symbols based at least in part on a symbol duration according to a reference subcarrier spacing, and the reference subcarrier spacing is a smallest subcarrier spacing between a subcarrier spacing configuration of physical downlink control channel (PDCCH) carrying the signaling and a smallest subcarrier spacing configuration provided for UL; the reference time includes at least one of: a starting symbol of a first CG occasion of the CG configuration; a last symbol of the first CG occasion of the CG configuration; or a last symbol of UCI used to transmit the indication of one or more groups of the transmission occasions that include at least one unused transmission occasion.

Some implementations of the methods and apparatuses described herein may further include: the set of transmission occasions are confined within a duration of time, and the duration of time includes an integer number of periods of the CG configuration; further including determining the threshold gap based at least in part on one or more of higher layer signaling or an apparatus capability reporting signaling; in an event that the gap is not larger than the threshold gap, determining the one or more groups of the transmission occasions that include at least one unused transmission occasion includes ignoring the dynamic cancellation signaling; further including: determining a time domain window (TDW) over which power consistency and phase continuity are to be maintained across physical uplink shared channel (PUSCH) transmissions for demodulation reference signal (DMRS) bundling; and indicating that one or more transmission occasions corresponding to the TDW are unused in an event that the one or more transmission occasions corresponding to the TDW including a DMRS symbol is indicated as unused; each group of transmission occasions is associated with a codepoint in a bit-field in UCI, and the bit-field indicates at most one group of transmission occasions as unused.

Some implementations of the methods and apparatuses described herein may further include: each group of transmission occasions is associated with a bit in a bit-field in UCI, and the bit-field indicates the one or more groups of the transmission occasions that include at least one unused transmission occasion; the signaling canceling the subset of transmission occasions of the set of transmission occasions includes one or more of an UL cancellation indication or a slot format indication (SFI), and one or more of: the UL cancellation indication cancels a transmission occasion in an event that a symbol of the transmission occasion is indicated by the UL cancellation indication as to be canceled; or the SFI indicates one or more of a change of one or more of an UL symbol or a flexible symbol to a downlink (DL) symbol; further including transmitting the first indication via UCI, and receiving the signaling canceling the subset of transmission occasions before transmission of the UCI.

Some implementations of the methods and apparatuses described herein may further include transmitting, by an apparatus, a first indication of one or more unused transmission occasions of a CG configuration within a duration of time; receiving signaling canceling a subset of one or more transmission occasions of the CG configuration within the duration of time, the subset including at least one transmission occasion not identified in the indication of the one or more unused transmission occasions; and processing at least a portion of a data burst for transmission in at least a second transmission occasion of the CG configuration, the second transmission occasion indicated as unused in the first indication of the one or more unused transmission occasions.

Some implementations of the methods and apparatuses described herein may further include: receiving a configuration to configure the apparatus to indicate unused transmission occasions of the CG configuration within the duration of time; transmitting the first indication of one or more unused transmission occasions via UCI; processing the at least a portion of the data burst for transmission in the at least a second transmission occasion includes receiving a second indication indicating whether the at least a portion of the data burst is transmittable in the at least a second transmission occasion of the CG configuration; the second indication includes a maximum number of transmission occasions that are usable for transmission of the at least a portion of the data burst, and the transmission occasions of the maximum number of transmission occasions are indicated by the first indication as unused; the apparatus is configured with a gap threshold, and processing the at least a portion of the data burst includes not transmitting the at least a portion of the data burst in the at least the second transmission occasion in an event that a first gap between transmission of the first indication and receiving the signaling canceling the subset of one or more transmission occasions is larger than the gap threshold.

Some implementations of the methods and apparatuses described herein may further include: the first gap includes a time duration between an end of transmission of the first indication and a first symbol of a CORESET including the signaling canceling the subset of one or more transmission occasions; the signaling canceling the subset of one or more transmission occasions includes one or more of an UL cancellation indication or SFI, and one or more of: the UL cancellation indication cancels a transmission occasion in an event that a symbol of the transmission occasion is indicated by the UL cancellation indication to be canceled; or the SFI indicates a change of one or more of an UL symbol or a flexible symbol to a DL symbol; further including transmitting the first indication via UCI, and receiving the signaling canceling the subset of one or more transmission occasions after transmission of the UCI.

Some implementations of the methods and apparatuses described herein may further include transmitting, by a first apparatus, a configuration to configure a second apparatus to indicate unused transmission occasions of a set of transmission occasions of a CG configuration within a duration of time, the configuration including one or more transmission occasion grouping behaviors that are applicable based on a gap between signaling canceling a subset of transmission occasions of the set of transmission occasions and a reference time associated with the CG configuration; and receiving, from the second apparatus, an indication of one or more groups of the transmission occasions that include at least one unused transmission occasion.

Some implementations of the methods and apparatuses described herein may further include: the one or more transmission occasion grouping behaviors include: a first grouping rule that specifies that in an event that the gap is not larger than a gap threshold, group the transmission occasions of the set of transmission occasions according to a first grouping rule; and a second grouping rule that specifies that in an event that the gap is larger than the gap threshold, group the transmission occasions of the set of transmission occasions according to a second grouping rule; a number of transmission occasions in one or more groups associated with the second grouping rule is smaller than a number of transmission occasions in one or more groups associated with the first grouping rule; further including transmitting the signaling canceling the subset of transmission occasions of the set of transmission occasions within a duration of time.

Some implementations of the methods and apparatuses described herein may further include receiving, at a first apparatus and from a second apparatus, a first indication of one or more unused transmission occasions of a CG configuration within a duration of time; transmitting, to the second apparatus, signaling canceling a subset of one or more transmission occasions of the CG configuration within the duration of time, the subset including at least a first transmission occasion not identified in the indication of the one or more unused transmission occasions; and transmitting, to the second apparatus, a second indication identifying a gap threshold for use in determining whether at least a portion of a data burst is transmittable by the second apparatus in at least a second transmission occasion of the CG configuration, the second transmission occasion being indicated by the first indication as unused; alternatively or additionally, the second indication indicates whether the at least a portion of the data burst is transmittable by the second apparatus in at least the second transmission occasion of the CG configuration, and the second indication does not indicate the gap; the gap is determined, no need for indication.

Some implementations of the methods and apparatuses described herein may further include: the gap threshold is configured to be used by the second apparatus to determine whether a gap between the first indication and a reference time is larger or not larger than the gap threshold; the second indication indicates whether the at least a portion of the data burst is transmittable by the second apparatus in the at least a second transmission occasion of the CG configuration; the second indication includes a maximum number of transmission occasions that are usable for transmission of the at least a portion of the data burst, and the transmission occasions of the maximum number of transmission occasions are indicated by the first indication as unused; further including transmitting, to the second apparatus, a configuration to configure the second apparatus to indicate the first indication of the one or more unused transmission occasions of the CG configuration within the duration of time.

### BRIEF DESCRIPTION OF THE DRAWINGS

FIG. 1 illustrates an example of a wireless communications system that supports indication for unused transmission occasions for uplink cancellation in accordance with aspects of the present disclosure.

FIG. 2 illustrates an example scenario for indicating unused CG in a period.

FIG. 3 illustrates an example scenario that supports indication for unused transmission occasions for uplink cancellation in accordance with aspects of the present disclosure.

FIG. 4 illustrates a scenario that supports indication for unused transmission occasions for uplink cancellation according to aspects of the present disclosure.

FIG. 5 illustrates a scenario that supports indication for unused transmission occasions for uplink cancellation in accordance with aspects of the present disclosure.

FIG. 6 illustrates an example scenario that supports indication for unused transmission occasions for uplink cancellation in accordance with aspects of the present disclosure.

FIG. 7 illustrates a scenario that supports indication for unused transmission occasions for uplink cancellation in accordance with aspects of the present disclosure.

FIGS. 8 and 9 illustrate examples of block diagrams of devices that support indication for unused transmission occasions in accordance with aspects of the present disclosure.

FIGS. 10-13 illustrate flowcharts of methods that support indication for unused transmission occasions in accordance with aspects of the present disclosure.

### DETAILED DESCRIPTION

In wireless communications systems, a UE can be configured by a network entity with multiple CG configurations for UL transmission. Further, UCI multiplexed with an UL transmission associated with a CG configuration can indicate unused CG transmission occasions within a time duration. A dynamic UL cancellation signal (such as SFI or uplink cancellation information (UL-CI)) may cancel an UL transmission on some of the CG transmission occasions within the time duration, which can potentially impact which CG transmission occasions are unused or can be indicated as unused. Current ways for indicating unused CG transmission occasions, however, may be inefficient and not account for variations in arrangement of unused CG transmission occasions.

Accordingly, the present disclosure relates to methods, apparatuses, and systems that support indication for unused transmission occasions for uplink cancellation. For instance, implementations provide for ways for enabling UEs and network entities (e.g., gNB) to be synchronized regarding unused CG transmission occasions (TO) within a determined duration of time. In implementations, for example, regrouping of CG TO for unused TO provides unused CG TO group indications based on dynamically cancelled TOs. Further, and based at least in part on a time gap between dynamic UL cancellation and UCI, a UE can determine unused CG TO and indicate them to a network entity and can determine whether to transmit a TB of a canceled CG TO in another CG TO that has been indicated as unused.

By utilizing the described techniques, a UE and a network entity can be mutually aware of unused CG TO, which can enable the UE to efficiently utilize available CG TO and the network entity to schedule transmissions (e.g., by the UE or other UEs) on available (e.g. unused) CG resources. This can enable more efficient utilization and scheduling of available CG resources.

Aspects of the present disclosure are described in the context of a wireless communications system. Aspects of the present disclosure are further illustrated and described with reference to device diagrams and flowcharts.

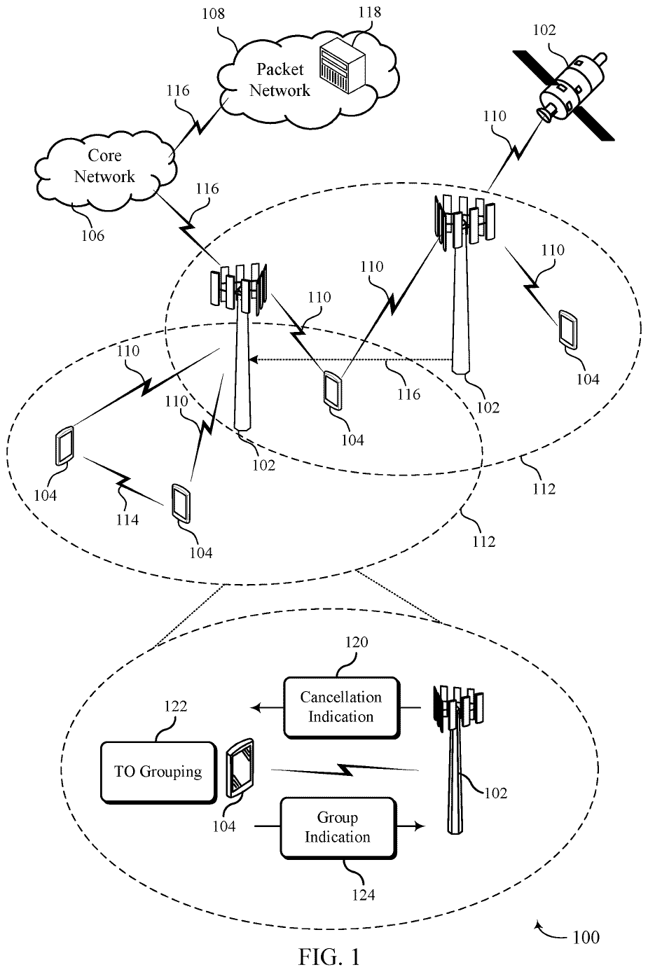

FIG. 1 illustrates an example of a wireless communications system 100 that supports indication for unused transmission occasions for uplink cancellation in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a PDU session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHZ), FR4a or FR4-1 (52.6 GHz-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for indication for unused transmission occasions for uplink cancellation, a network entity 102 generates a cancellation indication 120 and transmits the cancellation indication 120 to a UE 104. The cancelation indication 120, for instance, represents signaling canceling a subset of TO of a set of TO of a CG configuration. Examples of the cancelation indication 120 are discussed throughout this disclosure, such as UL-CI, SFI, etc.

Based at least in part on receiving the cancelation indication 120 the UE 104 executes TO grouping 122. The TO grouping 122, for instance, groups TO of the set of TO based on a gap between the received cancelation indication 120 and a reference time associated with the CG configuration. The TO grouping 122 can be based on different grouping behaviors, such as grouping the TO of the set of TO according to a first grouping rule based at least in part on the gap being not larger than a gap threshold, and/or grouping the TO of the set of TO according to a second grouping rule based at least in part on the gap being larger than the gap threshold.

Based at least in part on the TO grouping 122, the UE 104 generates a group indication 124 and transmits the group indication 124 to the network entity 102. The group indication 124, for instance, indicates one or more groups of the grouped TO that include at least one unused TO.

In some wireless communications systems, for CG scenarios, UL data transmission (e.g., PUSCH) may be scheduled with downlink control information (DCI) on PDCCH, or a semi-static configured grant may be provided over RRC, where two types of operation are supported:
The first PUSCH is triggered with a DCI, with subsequent PUSCH transmissions following the RRC configuration and scheduling received on the DCI, or.
The PUSCH is triggered by data arrival to the UE's transmit buffer and the PUSCH transmissions follow the RRC configuration.

For CG operation with shared spectrum channel access, a CG-UCI (Configured Grant Uplink Control Information) can be transmitted in PUSCH scheduled by configured uplink grant.

Considering multiple occasions within a CG period, large video frame sizes may utilize more than one PUSCH occasion to be transmitted. For instance, 1-5 PUSCHs per video frame may be used depending on the channel condition and the video frame size. One way is to configure multiple PUSCH occasions within a CG period. Such an approach can be supported for shared spectrum as below:

Technical specification (TS) 38.214 Clause 6.1.2.3 specifies that for resource allocation for uplink transmission with configured grant: . . . . A set of allowed periodicities P are defined in TS 38.331. The higher layer parameter cg-nrofSlots, provides the number of consecutive slots allocated within a configured grant period. The higher layer parameter cg-nrofPUSCH-InSlot provides the number of consecutive PUSCH allocations within a slot, where the first PUSCH allocation follows the higher layer parameter timeDomainAllocation for Type 1 PUSCH transmission or the higher layer configuration according to TS 38.321, and UL grant received on the DCI for Type 2 PUSCH transmissions, and the remaining PUSCH allocations have the same length and PUSCH mapping type, and are appended following the previous allocations without any gaps. The same combination of start symbol and length and PUSCH mapping type repeats over the consecutively allocated slots.

In some scenarios, a CG resource is semi-statically configured and thus may have difficulty adapting to the varying size of video frames, such as the ones associated with extended reality such as virtual reality and or augmented reality. If the number of configured resources is not sufficient for transmission of a video frame, some scheduling delay associated with the dynamic scheduling could occur for scheduling the rest of the video frame that could not be fit in the configured resources.

To avoid delay that may be caused by additional dynamic scheduling, the CG resource within one CG period can be configured according to a relatively large size for transmission of a video frame. Upon arrival of the video frame at UE's buffer, the UE can determine how much resource out of the configured resources within one CG period is to be used and can indicate the unused number of resources to gNB so that gNB can schedule other UL transmissions (e.g., for the same UE or a different UE) in at least some of the unused resources, such as transmission occasions and/or time-domain resources. The indication can be via UCI or MAC control element (CE) and can be transmitted in the first CG PUSCH occasion. Note that the indication can potentially indicate unused CG occasions and/or resources associated with multiple configured configurations, e.g., in one CG period or in multiple CG periods.

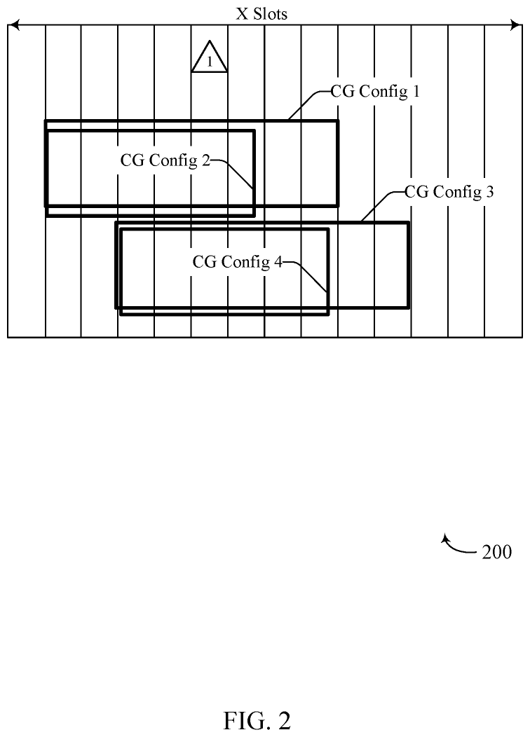

FIG. 2 illustrates an example scenario 200 for indicating unused CG in a period. In the scenario 200, for instance, an indication in a physical uplink control channel (PUCCH) resource 1/CG-UCI indicates if a TB transmission occurs in 1^{st} (CG Config 1), 2^{nd} (CG Config 2) 3^{rd} (CG Config 3), and 4^{th} (CG Config 4) CG configuration. For example, alternatively to a CG configuration with multiple PUSCH occasions within a period, multiple CG configurations each providing one PUSCH occasion can be used to accommodate varying packet size (e.g., from one video frame to another video frame) by selecting one of the CG configurations to transmit a video frame. A CG-UCI in one of the CG configurations can indicate which CG configuration is used in a time window, e.g., when the CGs used for UL transmission of an extended reality (XR) packet have the same periodicity but different resource duration in time domain. For instance, a UCI in a PUSCH occasion of one of the CGs can indicate which CGs are unused in a period, e.g., CG2 is used, and CG1, CG3, and CG4 have unused PUSCH occasions as illustrated in the scenario 200. Accordingly, this disclosure provides additional details for such implementations, e.g., details for when UL cancellation indication cancels a CG occasion of a CG configuration, such as in terms of timeline parameters pertaining to a UCI indication.

Accordingly, solutions are provided in this disclosure for indication for unused transmission occasions for uplink cancellation. For purposes of discussion throughout this disclosure, the terms CG transmission occasions, CG resources, and PUSCH occasions can be used interchangeably. Further, dynamic UL cancellation signaling, UL-CI, SFI, dynamic scheduling of DL channel(s) and/or DL signal(s) on flexible symbol(s), and dynamic scheduling of UL channel(s) and/or signal(s) overlapping with CG transmission occasions can be used interchangeably to indicate that a UL CG transmission occasion is canceled. Note that although these different types of signaling (e.g., UL-CI and SFI) may have different functionalities, they each can cancel a CG-based UL transmission in a TO.

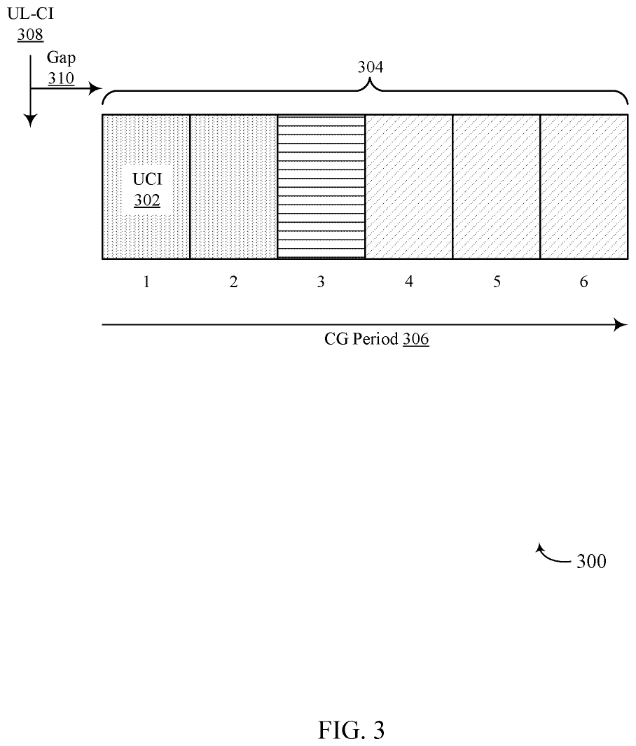

FIG. 3 illustrates an example scenario 300 that supports indication for unused transmission occasions for uplink cancellation in accordance with aspects of the present disclosure. The scenario 300, for instance, illustrates an implementation where dynamic UL cancellation occurs before a UCI 302. The scenario 300 includes six (1-6) CG transmission occasions (TO) 304 within a CG period 306. A data burst that is available at the beginning of the CG period 306 requires only three out of six CG TO 304. Further, UL-CI 308 cancels UL transmission in TO3. The scenario 300 also illustrates a gap 310 between the UL-CI 308 and the UCI 302.

In implementations, the gap 310 may be larger than a gap threshold. In such implementations, a UE may have sufficient time to determine that to transmit a data burst, TB, packet, and/or video frame, TO1, TO2, and TO4 (e.g., where a similar number of resource elements (RE) being available in TO4 as the number of RE available in TO3) are to be used. UL transmission in TO3, for instance, is not allowed according to UL-CI 308 indication. Further, the UE in the UCI 302 indicates TO5 and TO6 as being unused.

In implementations, the gap 310 (e.g., referred to as a 1st gap) can be defined as a time duration between:
An end of the dynamic UL-CI 308 signaling and an end of the UCI 302 transmission;
An end of the dynamic UL-CI 308 signaling and a beginning of the UCI 302 transmission;
An end of the dynamic UL-CI 308 signaling and a beginning of the first CG-TO of the CG configuration within a duration of time (e.g., CG period);
A beginning of the dynamic UL-CI 308 signaling and a beginning of the UCI 302 transmission;
A beginning of the dynamic UL-CI 308 signaling and an end of the UL-CI 308 transmission; and/or
A last symbol of a CORESET including the dynamic UL-CI 308 signaling and a beginning or end of the UCI 302 transmission.

In implementations a gap may additionally include an offset which can be added to the gap 310 determined above. For instance, the offset can be based on at least one of:
Timing advance (TA);
A reference subcarrier spacing (SCS), such as:
   A smaller SCS associated with a) a dynamic UL-CI signaling and b) the UCI; or
   A smallest SCS configuration between the SCS configuration of the PDCCH carrying the dynamic UL-CI signaling and the smallest SCS configuration provided in scs-SpecificCarrierList of FrequencyInfoUL or FrequencyInfoUL-SIB.

In implementations a threshold gap is determined based on UE capability reporting such as based on reported capability associated with PUSCH preparation time, e.g., N2 symbols according to a reference SCS such as UL SCS or offsets to Tproc,2 defined in TS 38.214.

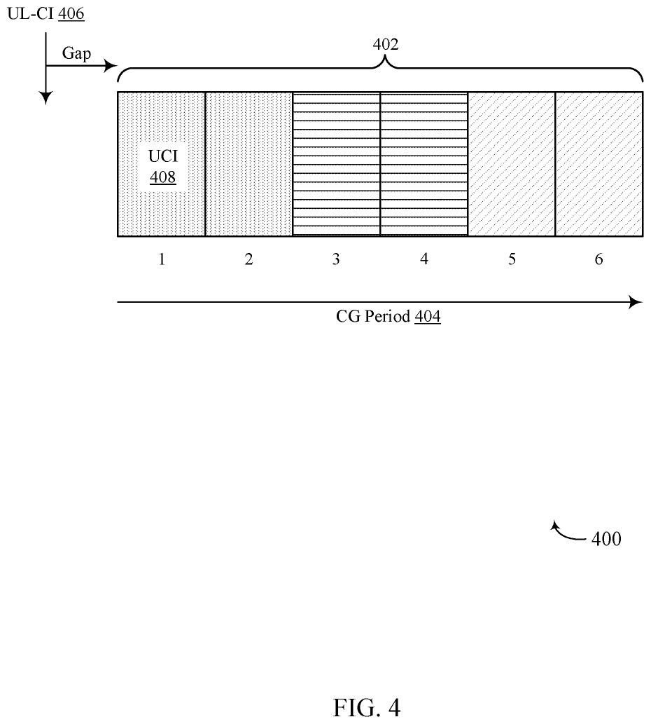

In implementations, one or more of the following may apply for indications of unused TO when some TO are canceled:
1. A UE may not be expected to indicate the TO that is canceled by UL-CI (e.g., TO3 in the scenario 300) to be unused. In additional or alternative implementations, the UE can indicate TO3 as unused and/or a gNB ignores UCI for TO3.
2. When both the UE and the gNB know TO3 is voided/canceled (e.g., by UL-CI), the UE can indicate whether the next TO (e.g., TO7) that does not belong to TO1-TO6 in the scenario 300 (e.g., associated with the same CG configuration but in the next CG period or associated with a different CG configuration) is unused. If a formula is used to indicate the unused occasions (e.g., start and length indicator value (SLIV)-like), the formula parameters can be adjusted by eliminating the voided/canceled TOs, e.g., TO3 in the scenario 300.
3. In implementations a slot and/or CG transmission occasion is not counted in a number of slots and/or CG transmission occasions that can be indicated unused if at least one of the symbols indicated by the indexed row of the used resource allocation table for CG UL transmissions in the slot and/or CG TO overlaps with a symbol of a synchronization signal physical broadcast channel (SS/PBCH) block with index provided by ssb-PositionsInBurst, or overlaps with a canceled CG TO, where the cancellation occurs due to UL-CI or other dynamic cancellation signaling.
4. If the number of voided/canceled TOs are such that fewer bits are needed in the UCI to indicate unused TO, the UE can use less bits for UCI indication of unused CG TO since the gNB is also aware of the unused TO, such as where UL-CI is reliably received by the UE.
5. If multiple TOs are grouped for the sake of indication of unused TOs according to a first TO grouping rule, in scenarios where some TOs are cancelled by dynamic UL-CI signaling, un-voided and/or uncancelled TOs can be grouped according to a second TO grouping rule, such as illustrated in FIG. 4.

FIG. 4 illustrates a scenario 400 that supports indication for unused transmission occasions for uplink cancellation according to aspects of the present disclosure. The scenario 400 includes six 6 (1-6) CG TO 402 within a CG period 404. In the scenario 400 data that is available at the beginning of the CG period 404 requires only three out of six CG TO 402. A UL-CI 406 cancels UL transmission in TO3 and TO4. A UCI 408 has 3 bits for indication of unused TOs and TO2-TO6 are grouped into 3 groups and each group can correspond to 1 bit in the indication. For instance if TOs of Group 1 are unused the indication can assign bit value ‘1’ for Group 1 and if at least one TO of Group 1 is used, the indication can assign bit value ‘0’ for Group 1). In implementations where no dynamic UL cancellation occurs, the groups can be Group1 (TO2); Group2 (TO3, TO4), and Group3 (TO5, TO6). In scenarios where dynamic UL cancellation occurs and cancels TO3 and TO4, the remaining TOs can be grouped into three groups as follows: Group 1 (TO2); Group2 (TO5), and Group3 (TO6), which can result in better resource usage as individual TOs can be indicated as unused. In implementations TO6 could not have been indicated as unused according to the first grouping as it was grouped with TO5 which was indicated to be used (e.g., due to UL-CI reception and replacing transmission in TO3 by a transmission in TO5), whereas with the second grouping TO6 can be indicated as unused.

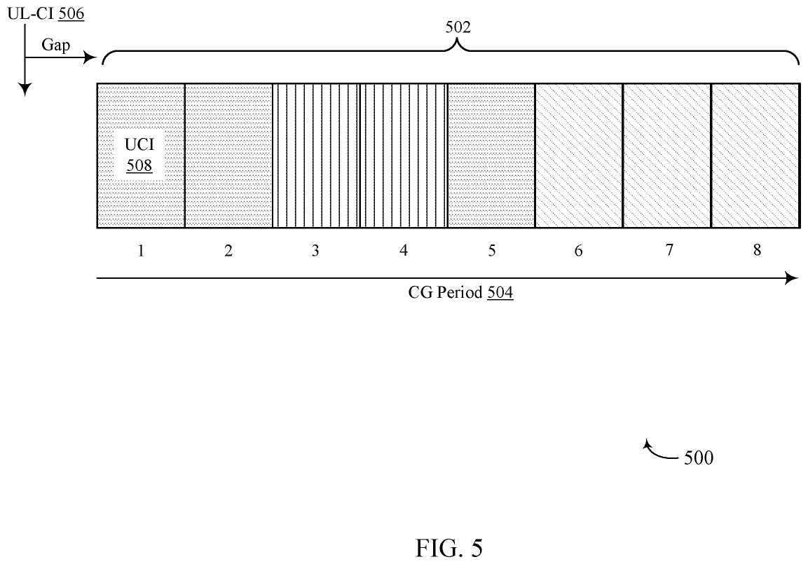

FIG. 5 illustrates a scenario 500 that supports indication for unused transmission occasions for uplink cancellation in accordance with aspects of the present disclosure. The scenario 500 includes eight (1-8) CG TO 502 within a CG period 504. Data that is available at the beginning of the CG period 504 requires five out of eight CG TO 502. UL-CI 506 cancels UL transmission in TO3 and TO4. Further, a UCI 508 has 2 bits for indication of unused TOs. In implementations a UE will not attempt transmitting TBs of cancelled TO3 and TO4 in TO6 and TO7.

In implementations another TO grouping (e.g., assuming 2 bits in the UCI 508 for indication of unused groups of TOs) for the scenario 500 can be:
First grouping rule: Group1 (0 TOs unused); Group2 (TO3-TO8 unused); Group3 (TO4-TO8 unused); Group4 (TO5-TO8 unused).
Second grouping rule: Group1 (0 TOs unused); Group2 (TO5-TO8 unused); Group3 (TO6-TO8 unused); Group4 (TO7-TO8 unused).

In implementations where all TOs of a group are unused, that group can be indicated to be unused in the UCI 508. Regrouping may use additional processing time which can be reflected in the threshold gap such as defined above. For instance, the gap between UL-CI 506 and the UCI 508 is to be larger than ‘T’, where ‘T’ is based at least in part on PUSCH processing time with a parameter being configured in scenarios where regrouping is enabled and/or configured.

In implementations TO6-TO8 may not have been indicated as unused according to the first grouping rule as TO6-TO8 were grouped with TO5 which was indicated to be used instead of TO4 that was canceled due to reception of the UL-CI 506. Using the second grouping rule, TO6-TO8 can be indicated as unused.

In implementations another example TO grouping (e.g., assuming 2 bits in the UCI 508 for indication of unused groups of TO) for the scenario 500 can be:
First grouping rule: Group1 (0 TOs unused); Group2 (TO4-TO8); Group3 (TO5-TO8); Group4 (TO7-TO8).
Second grouping rule: Group1 (0 TOs unused); Group2 (TO5-TO8); Group3 (TO6-TO8); Group4 (TO7-TO8).

In implementations where all TOs of a group are unused, that group can be indicated to be unused in the UCI 508. Further, if the UE skips transmission of canceled TO in unused TO (e.g., postpones the remaining transmissions to another CG period), TO6 may not have been indicated as unused according to the first grouping rule, whereas with the second grouping rule, TO6 can be indicated as unused.

In implementations a UE is configured with a lookup table with ‘W’ rows, such as illustrated below in Table 1. Each row can be associated with a set of indices of CG TO within a given time duration. The set of indices of CG TO can be different for different rows. Corresponding to each set of indices of CG TO, there can be a grouping and/or mapping of CG occasions to ‘2\hat{ }N’ groups, where ‘N’ can be configured and can represent a number of bits for the CG-UCI field indicating the unused CG TO.

For instance, consider an example where ‘N=2’, and thus the CG TO are grouped into 4 groups. Further, assume there are 8 CG TOs in the given time duration, e.g., one period of a CG configuration. A default CG TO to CG group mapping that is also configured can be G1 ([null]), G2 (TO2-TO8), G3 (TO4-TO8), G4 (TO6-TO8), wherein Gi is the ith group and if the UCI indicates group i, this indicates that the TOs in the group are unused, e.g., if UCI indicates G3, this indicates that TO4-TO8 are unused. An example lookup table is presented below in Table 1.

TABLE 1

| Set of canceled CG TOs (set of | |
|---|---|
| indices of CG occasions) | CG TO to CG group mapping |
| [ ] (empty set): this is the default | Default: |
| set | G1([ ]), G2(TO2-TO8), G3(TO4- |
| | TO8), G4(TO6-TO8) |
| (TO2, TO3) | G1([ ]), G2(TO4-TO8), G3(TO5- |
| | TO8), G4(TO6-TO8) |
| (TO2, TO3, TO4) or (TO3, TO4) | G1([ ]), G2(TO5-TO8), G3(TO6- |
| | TO8), G4(TO7-TO8) |
| (TO5, TO6) | G1([ ]), G2(TO2-TO4), G3(TO3- |
| | TO4), G4(TO7-TO8) |
| (TO2, TO4, TO6) | G1([ ]), G2(TO3-TO8), G3(TO5- |
| | TO8), G4(TO7-TO8) |
| . . . | . . . |

In implementations, if a set of canceled CG TO is not associated with a row of the Table 1, the default CG TO to CG group mapping can be applied. Implementations can also utilize multiple defined lookup tables. For instance, a first lookup table for mapping CG TO to CG groups when replacement of transmissions in cancelled TO is enabled, and a second lookup table for mapping CG TO to CG groups when replacement of transmissions in cancelled TO is disabled.

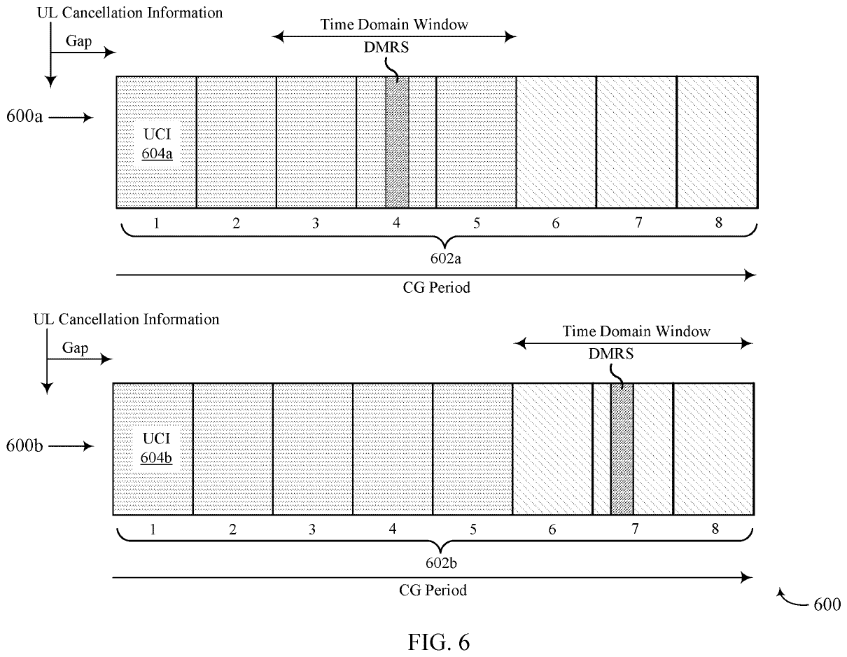

FIG. 6 illustrates an example scenario 600 that supports indication for unused transmission occasions for uplink cancellation in accordance with aspects of the present disclosure. For instance, in the scenario 600 TOs of a TDW are either used or unused, or they follow the TO that contains DMRS. The scenario 600 includes CG TO 602a and UCI 604a in the top portion 600a and CG TO 602b and UCI 604b in the bottom portion 600b. At 600a, TO3-TO5 are indicated as used and TO4 includes DMRS for TO3-TO5. At 600b TO6 and TO7 are indicated as unused and TO7 may include DMRS for TO6-TO8 if TO7 contains a PUSCH transmission. In implementations the UCI 604b indicates TO7 as unused, and thus TO6 and TO8 are to be considered and/or indicated as unused.

In scenarios a UE may determine a TDW over which power consistency and phase continuity are to be maintained across PUSCH transmissions for the purpose of DMRS bundling. In such scenarios, if UL-CI cancels a TO that contained DMRS for the TDW, the UE may be expected to indicate remaining portions of the TDW to be unused. Further, in implementations the UE is expected to indicate all TO of the TDW as unused if all or at least one of the TO including DMRS are indicated as unused such as illustrated in the scenario 600.

In implementations a gap between UL-CI and UCI may be smaller than a gap threshold. In such scenarios, a UE may not have enough time to determine that to transmit a TB/data burst which TOs are required, for instance, in an example shown in FIGS. 3, TO1, TO2, and TO4 are required. For instance, UL transmission in TO3 is not allowed according to a UL-CI indication. Accordingly, the UE in UCI can indicate TO4, TO5, and TO6 as being unused. Further, a network entity may not know whether the UCI indicating unused TOs has taken into account the cancelled UL transmissions via the dynamic cancellation signaling, e.g., UL-CI. In implementations, if the gap between the dynamic UL-CI and the UCI is smaller than the gap threshold, the UE may not take into account the dynamic UL-CI in determining unused transmission occasions. In implementations and pertaining to UE behavior, irrespective of the gap between the dynamic UL-CI and the UCI, the UE may not take into account the dynamic UL-CI in determination of unused TO.

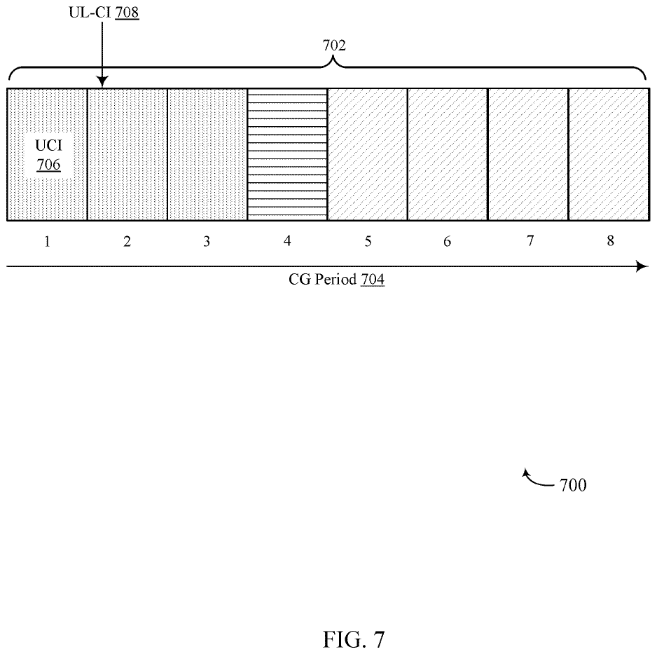

FIG. 7 illustrates a scenario 700 that supports indication for unused transmission occasions for uplink cancellation in accordance with aspects of the present disclosure. The scenario 700, for instance, represents implementations where dynamic UL-CI comes after UCI. The scenario 700 includes eight (1-8) CG transmission occasions (TO) 702 within a CG period 704. Further, a data burst and/or packet that is available at the beginning of the CG period 704 requires only 4 out of the 8 CG TO 792. Accordingly, a UCI 706 indicates TO5-TO8 as unused. A UL-CI 708 cancels UL transmission in TO4. Hence, a UE can use TO5 for transmission of the remainder of the TB and/or packet (that was supposed to be transmitted in TO4 but could not be transmitted in TO4 due to UL-CI) or alternatively, a UE skips transmission in TO5-TO8 as indicated by the UCI 706.

In implementations, the UE can indicate in a first CG transmission occasion (e.g., TO1 in the scenario 700) that a set of CG TO are unused. For instance, the set of CG TO at least includes a 2nd TO, e.g., TO5 in the scenario 700. Further, the UE can receive a dynamic indication (such as SFI or UL-CI) from a network entity canceling UL transmission in a 3rd TO, e.g., TO4 in the scenario 700.

In implementations and in response to reception of the dynamic indication, the UE can determine whether a portion of a data burst, TB, and/or packet can be transmitted in at least one TO of the set of CG TO, such as a 2nd TO, e.g., TO5 in the scenario 700. If the portion of a data burst, TB, and/or packet can be transmitted in the at least one TO, the UE can transmit in the 2nd TO, e.g., TO5 of the scenario 700. If the portion of a data burst, TB, and/or packet cannot be transmitted in at least one TO, the UE can skip and/or postpone transmission of the portion of a data burst, TB, and/or packet.

In implementations the 2nd TO can be determined at least based on one of a frequency hopping pattern. For instance, in the example of FIGS. 7, TO4 and TO6 may have the same or similar hopping offset (or hop) and thus the UE may transmit in TO6 (and not in TO5) instead of the cancelled TO4. Alternatively, TO5 can be used but the hop/hopping offset can be updated to be similar to that of TO4.

In implementations a UL-CI, a MAC-CE, DCI, and/or a configuration RRC message can indicate whether a UE is permitted to use a TO previously indicated as unused (e.g., TO5 in the scenario 700) to finish a transmission that was interrupted by UL-CI, e.g., cancelling TO4 in the scenario 700. A signaling (e.g., UL-CI, MAC-CE, DCI, and/or a configuration RRC message) can indicate up to how many of indicated unused TO can be used in case of UL-CI and/or a dynamic UL cancellation signaling cancels one or multiple TO. For instance, if UL-CI cancels 3 TO (e.g., TO2-TO4 in the scenario 700), RRC signaling may enable transmission of up to two of previously indicated unused TO, e.g., TO5 and TO6 can be used in the scenario 700. The remaining part of the data burst can be dropped, skipped, or be transmitted in a later PUSCH transmission.

In implementations if the number of available REs in the 2nd TO is different than that of the 3rd TO, the UE can perform a rate-matching operation to fit information (e.g., portion of a data burst, TB, and/or packet) into the 2nd TO. Further, if the number of available REs is significantly different (e.g., more than a threshold) in TO5 compared to TO4, UE processing time may occur, e.g., to split the TB of TO4 into 2 TB, such as for TO5 and TO6. This may result in a later start of TO5, e.g., start of UL transmission from the 2nd symbol of TO5 instead of the first symbol of TO5.

Accordingly, in implementations the UE can be configured with a gap threshold and if the gap between the UCI and UL-CI and/or the gap between the UCI and the 2nd TO is larger than the gap threshold, the UE may not transmit the portion of the data burst, TB, and/or packet in the 2nd TO. Thus, UCI indicating unused TO may assist a network entity (e.g., gNB) in scheduling other UEs in resources associated with the unused TO. If the gap between UCI and UL-CI is large, this may indicate/imply that the network entity has already scheduled one or more other UEs in the indicated unused TO and thus the UE is not to occupy a TO that was indicated unused for finishing a transmission.

In implementations the gap is defined to be the time duration between:
An end of the UCI transmission and an end of the dynamic UL cancellation signaling;
An end of the UCI transmission and a beginning of the dynamic UL cancellation signaling;
An end of the UCI transmission and a first symbol of a CORESET including the dynamic UL cancellation signaling;
An end of the UCI transmission, and the last symbol of a CORESET including the dynamic UL cancellation signaling;
A beginning of the UCI transmission and an end of the dynamic UL cancellation signaling;
A beginning of the UCI transmission and a beginning of the dynamic UL cancellation signaling;
A beginning of the UCI transmission and a first symbol of a CORESET including the dynamic UL cancellation signaling; and/or
A beginning of the UCI transmission and a last symbol of a CORESET including the dynamic UL cancellation signaling.

In implementations, instead of transmitting a portion of a data burst, TB, and/or packet in the 2nd TO such as described above in the scenario 700, the UE can skip the remainder of UL transmission (potentially to the next CG period or other available TO) and may not transmit in the indicated unused TO. Further, in implementations the UE may not be expected to transmit an UL transmission in a CG TO which has been indicated as unused unless there is pending data at the UE for transmission which can be transmitted on that CG TO or the UE has received a dynamic indication from the network (such as UL-CI or SFI) canceling a TO that was not indicated by the UE as unused.

In implementations the UE can determine the number of TO (e.g., which are already indicated as unused via a UCI) that can be used for transmission of UL data based on the number of TO canceled by dynamic UL cancellation signaling, e.g., which are not already indicated as unused via the UCI.

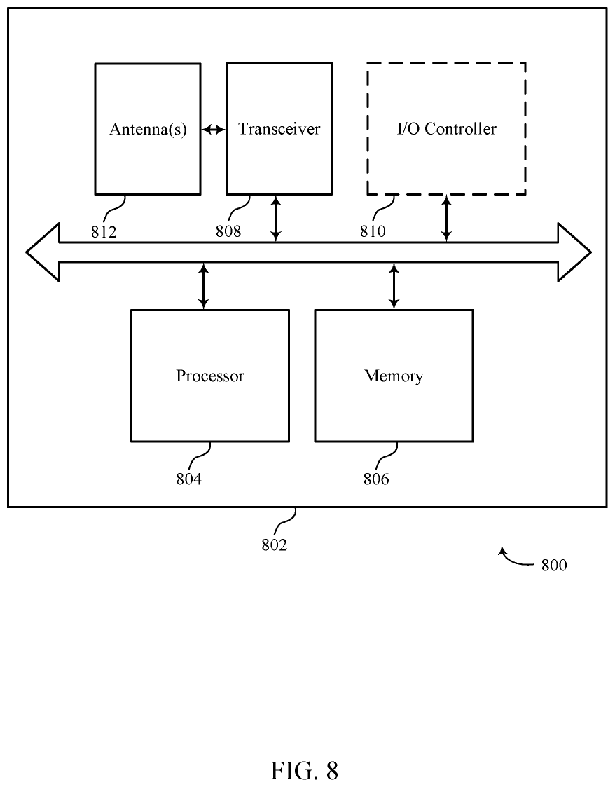

FIG. 8 illustrates an example of a block diagram 800 of a device 802 (e.g., an apparatus) that supports indication for unused transmission occasions for uplink cancellation in accordance with aspects of the present disclosure. The device 802 may be an example of UE 104 as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806). In the context of UE 104, for example, the transceiver 808 and the processor coupled 804 coupled to the transceiver 808 are configured to cause the UE 104 to perform the various described operations and/or combinations thereof.

For example, the processor 804 and/or the transceiver 808 may support wireless communication at the device 802 in accordance with examples as disclosed herein. For instance, the processor 804 and/or the transceiver 808 may be configured as and/or otherwise support a means to receive signaling canceling a subset of transmission occasions of a set of transmission occasions of a CG configuration; group transmission occasions of the set of transmission occasions based on a gap between the received signaling and a reference time associated with the CG configuration, including one or more of to: group the transmission occasions of the set of transmission occasions according to a first grouping rule based at least in part on the gap being not larger than a gap threshold; or group the transmission occasions of the set of transmission occasions according to a second grouping rule based at least in part on the gap being larger than the gap threshold; and transmit an indication of one or more groups of the transmission occasions that include at least one unused transmission occasion.

Further, in some implementations, the set of transmission occasions are confined within a duration of time; the processor is configured to cause the apparatus to receive a configuration to configure the apparatus to indicate unused transmission occasions of the CG configuration within the duration of time; to group the transmission occasions of the set of transmission occasions according to the first grouping rule, the processor is configured to cause the apparatus to map the transmission occasions to different groups; a number of transmission occasions in one or more groups associated with the second grouping rule is smaller than a number of transmission occasions in one or more groups associated with the first grouping rule; to transmit the indication of one or more groups of the transmission occasions that include at least one unused transmission occasion, the processor is configured to cause the apparatus to transmit the indication via UCI within a duration of time.

Further, in some implementations, the gap includes a second duration of time based at least in part on a number of symbols between a last symbol of a CORESET including the signaling and a first symbol of the UCI; the processor is configured to cause the apparatus to determine a duration of the gap in the number of symbols based at least in part on a symbol duration according to a reference subcarrier spacing, and the reference subcarrier spacing is a smallest subcarrier spacing between a subcarrier spacing configuration of PDCCH carrying the signaling and a smallest subcarrier spacing configuration provided for UL; the reference time includes at least one of: a starting symbol of a first CG occasion of the CG configuration; a last symbol of the first CG occasion of the CG configuration; or a last symbol of UCI used to transmit the indication of one or more groups of the transmission occasions that include at least one unused transmission occasion; the set of transmission occasions are confined within a duration of time, and the duration of time includes an integer number of periods of the CG configuration.

Further, in some implementations, the processor is configured to cause the apparatus to determine the threshold gap based at least in part on one or more of higher layer signaling or an apparatus capability reporting signaling; in an event that the gap is not larger than the threshold gap, to determine the one or more groups of the transmission occasions that include at least one unused transmission occasion, the processor is configured to cause the apparatus to ignore the signaling; the processor is configured to cause the apparatus to: determine a TDW over which power consistency and phase continuity are to be maintained across PUSCH transmissions for DMRS bundling; and indicate that one or more transmission occasions corresponding to the TDW are unused in an event that the one or more transmission occasions corresponding to the TDW including a DMRS symbol is indicated as unused.

Further, in some implementations, each group of transmission occasions is associated with a codepoint in a bit-field in UCI, and the bit-field indicates at most one group of transmission occasions as unused; each group of transmission occasions is associated with a bit in a bit-field in UCI, and the bit-field indicates the one or more groups of the transmission occasions that include at least one unused transmission occasion; the signaling canceling the subset of transmission occasions of the set of transmission occasions includes one or more of an UL cancellation indication or SFI, and one or more of: the UL cancellation indication cancels a transmission occasion in an event that a symbol of the transmission occasion is indicated by the UL cancellation indication as to be canceled; or the SFI indicates one or more of a change of one or more of an UL symbol or a flexible symbol to a DL symbol; the processor is configured to cause the apparatus to transmit the first indication via UCI, and receive the signaling canceling the subset of transmission occasions before transmission of the UCI.

Further, the processor 804 and/or the transceiver 808 may be configured as and/or otherwise support a means to transmit a first indication of one or more unused transmission occasions of a CG configuration within a duration of time; receive signaling canceling a subset of one or more transmission occasions of the CG configuration within the duration of time, the subset including at least one transmission occasion not identified in the indication of the one or more unused transmission occasions; and process at least a portion of a data burst for transmission in at least a second transmission occasion of the CG configuration, the second transmission occasion indicated as unused in the first indication of the one or more unused transmission occasions.

Further, in some implementations, the processor is configured to cause the apparatus to receive a configuration to configure the apparatus to indicate unused transmission occasions of the CG configuration within the duration of time; transmit the first indication of one or more unused transmission occasions via UCI; receive a configuration to configure the apparatus to indicate unused transmission occasions of the CG configuration within the duration of time; to process the at least a portion of the data burst for transmission in the at least a second transmission occasion, the processor is configured to cause the apparatus to receive a second indication indicating whether the at least a portion of the data burst is transmittable in the at least a second transmission occasion of the CG configuration; the second indication includes a maximum number of transmission occasions that are usable for transmission of the at least a portion of the data burst, and the transmission occasions of the maximum number of transmission occasions are indicated by the first indication as unused.

Further, in some implementations, the apparatus is configured with a gap threshold, and to process the at least a portion of the data burst, the processor is configured to cause the apparatus to not transmit the at least a portion of the data burst in the at least the second transmission occasion in an event that a first gap between transmission of the first indication and receiving the signaling canceling the subset of one or more transmission occasions is larger than the gap threshold; the first gap includes a time duration between an end of transmission of the first indication and a first symbol of a CORESET including the signaling canceling the subset of one or more transmission occasions; the signaling canceling the subset of one or more transmission occasions includes one or more of an UL cancellation indication or a SFI, and one or more of: the UL cancellation indication cancels a transmission occasion in an event that a symbol of the transmission occasion is indicated by the UL cancellation indication to be canceled; or the SFI indicates a change of one or more of an UL symbol or a flexible symbol to a DL symbol; the processor is configured to cause the apparatus to transmit the first indication via UCI, and receive the signaling canceling the subset of one or more transmission occasions after transmission of the UCI.

The processor 804 of the device 802, such as a UE 104, may support wireless communication in accordance with examples as disclosed herein. The processor 804 includes at least one controller coupled with at least one memory, and the at least one controller is configured to and/or operable to cause the processor to receive signaling canceling a subset of transmission occasions of a set of transmission occasions of a CG configuration; group transmission occasions of the set of transmission occasions based on a gap between the received signaling and a reference time associated with the CG configuration, including one or more of to: group the transmission occasions of the set of transmission occasions according to a first grouping rule based at least in part on the gap being not larger than a gap threshold; or group the transmission occasions of the set of transmission occasions according to a second grouping rule based at least in part on the gap being larger than the gap threshold; and transmit an indication of one or more groups of the transmission occasions that comprise at least one unused transmission occasion.

Further, the processor 804 of the device 802, such as a UE 104, may support wireless communication in accordance with examples as disclosed herein. The processor 804 includes at least one controller coupled with at least one memory, and the at least one controller is configured to and/or operable to cause the processor to transmit a first indication of one or more unused transmission occasions of a CG configuration within a duration of time; receive signaling canceling a subset of one or more transmission occasions of the CG configuration within the duration of time, the subset comprising at least one transmission occasion not identified in the indication of the one or more unused transmission occasions; and process at least a portion of a data burst for transmission in at least a second transmission occasion of the CG configuration, the second transmission occasion indicated as unused in the first indication of the one or more unused transmission occasions.

Further, the at least one controller is configured to and/or operable to cause the processor 804 to perform various operations described herein, such as with reference to a UE 104 and/or the device 802.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor 804. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (e.g., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

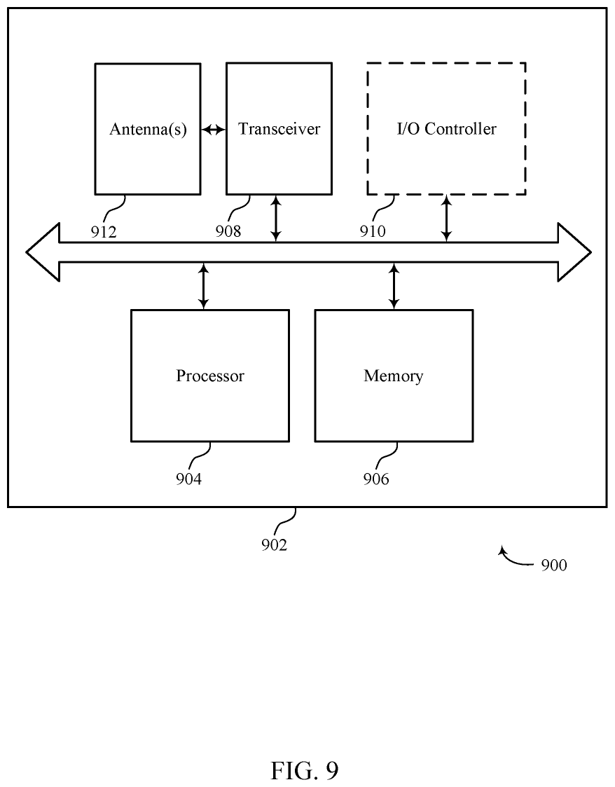

FIG. 9 illustrates an example of a block diagram 900 of a device 902 (e.g., an apparatus) that supports indication for unused transmission occasions for uplink cancellation in accordance with aspects of the present disclosure. The device 902 may be an example of a network entity 102 as described herein. The device 902 may support wireless communication with one or more network entities 102, UEs 104, or any combination thereof. The device 902 may include components for bi-directional communications including components for transmitting and receiving communications, such as a processor 904, a memory 906, a transceiver 908, and an I/O controller 910. These components may be in electronic communication or otherwise coupled (e.g., operatively, communicatively, functionally, electronically, electrically) via one or more interfaces (e.g., buses).

The processor 904, the memory 906, the transceiver 908, or various combinations thereof or various components thereof may be examples of means for performing various aspects of the present disclosure as described herein. For example, the processor 904, the memory 906, the transceiver 908, or various combinations or components thereof may support a method for performing one or more of the operations described herein.

In some implementations, the processor 904, the memory 906, the transceiver 908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 904 and the memory 906 coupled with the processor 904 may be configured to perform one or more of the functions described herein (e.g., executing, by the processor 904, instructions stored in the memory 906). In the context of network entity 102, for example, the transceiver 908 and the processor 904 coupled to the transceiver 908 are configured to cause the network entity 102 to perform the various described operations and/or combinations thereof.

For example, the processor 904 and/or the transceiver 908 may support wireless communication at the device 902 in accordance with examples as disclosed herein. For instance, the processor 904 and/or the transceiver 908 may be configured as or otherwise support a means to transmit, by a first apparatus, a configuration to configure a second apparatus to indicate unused transmission occasions of a set of transmission occasions of a CG configuration within a duration of time, the configuration including one or more transmission occasion grouping behaviors that are applicable based on a gap between signaling canceling a subset of transmission occasions of the set of transmission occasions and a reference time associated with the CG configuration; and receive, from the second apparatus, an indication of one or more groups of the transmission occasions that include at least one unused transmission occasion.

Further, in some implementations, the one or more transmission occasion grouping behaviors include: a first grouping rule that specifies that in an event that the gap is not larger than a gap threshold, group the transmission occasions of the set of transmission occasions according to a first grouping rule; and a second grouping rule that specifies that in an event that the gap is larger than the gap threshold, group the transmission occasions of the set of transmission occasions according to a second grouping rule; wherein a number of transmission occasions in one or more groups associated with the second grouping rule is smaller than a number of transmission occasions in one or more groups associated with the first grouping rule; the processor is configured to cause the first apparatus to transmit the signaling canceling the subset of transmission occasions of the set of transmission occasions within a duration of time.

Further, the processor 904 and/or the transceiver 908 may be configured as or otherwise support a means to receive, at a first apparatus and from a second apparatus, a first indication of one or more unused transmission occasions of a CG configuration within a duration of time; transmit, to the second apparatus, signaling canceling a subset of one or more transmission occasions of the CG configuration within the duration of time, the subset including at least a first transmission occasion not identified in the indication of the one or more unused transmission occasions; and transmit, to the second apparatus, a second indication identifying a gap threshold for use in determining whether at least a portion of a data burst is transmittable by the second apparatus in at least a second transmission occasion of the CG configuration, the second transmission occasion being indicated by the first indication as unused.

Further, in some implementations, the second indication includes a maximum number of transmission occasions that are usable for transmission of the at least a portion of the data burst, wherein the transmission occasions of the maximum number of transmission occasions are indicated by the first indication as unused; the processor is configured to cause the first apparatus to transmit, to the second apparatus, a configuration to configure the second apparatus to indicate the first indication of the one or more unused transmission occasions of the CG configuration within the duration of time.

The processor 904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 904 may be configured to operate a memory array using a memory controller. In some other implementations, a memory controller may be integrated into the processor 904. The processor 904 may be configured to execute computer-readable instructions stored in a memory (e.g., the memory 906) to cause the device 902 to perform various functions of the present disclosure.

The memory 906 may include random access memory (RAM) and read-only memory (ROM). The memory 906 may store computer-readable, computer-executable code including instructions that, when executed by the processor 904 cause the device 902 to perform various functions described herein. The code may be stored in a non-transitory computer-readable medium such as system memory or another type of memory. In some implementations, the code may not be directly executable by the processor 904 but may cause a computer (e.g., when compiled and executed) to perform functions described herein. In some implementations, the memory 906 may include, among other things, a basic I/O system (BIOS) which may control basic hardware or software operation such as the interaction with peripheral components or devices.

The I/O controller 910 may manage input and output signals for the device 902. The I/O controller 910 may also manage peripherals not integrated into the device M02. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. In some implementations, the I/O controller 910 may be implemented as part of a processor, such as the processor M06. In some implementations, a user may interact with the device 902 via the I/O controller 910 or via hardware components controlled by the I/O controller 910.

In some implementations, the device 902 may include a single antenna 912. However, in some other implementations, the device 902 may have more than one antenna 912 (e.g., multiple antennas), including multiple antenna panels or antenna arrays, which may be capable of concurrently transmitting or receiving multiple wireless transmissions. The transceiver 908 may communicate bi-directionally, via the one or more antennas 912, wired, or wireless links as described herein. For example, the transceiver 908 may represent a wireless transceiver and may communicate bi-directionally with another wireless transceiver. The transceiver 908 may also include a modem to modulate the packets, to provide the modulated packets to one or more antennas 912 for transmission, and to demodulate packets received from the one or more antennas 912.

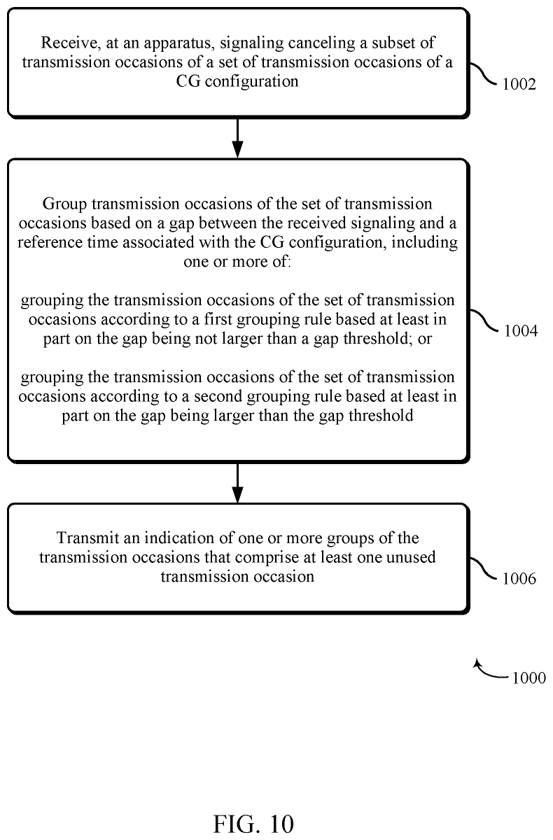

FIG. 10 illustrates a flowchart of a method 1000 that supports indication for unused transmission occasions for uplink cancellation in accordance with aspects of the present disclosure. The operations of the method 1000 may be implemented by a device or its components as described herein. For example, the operations of the method 1000 may be performed by a UE 104 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1002, the method may include receiving, at an apparatus, signaling canceling a subset of transmission occasions of a set of transmission occasions of a CG configuration. The operations of 1002 may be performed in accordance with examples as described herein. In some implementations, aspects of the operations of 1002 may be performed by a device as described with reference to FIG. 1.

At 1004, the method may include grouping transmission occasions of the set of transmission occasions based on a gap between the received signaling and a reference time associated with the CG configuration, including one or more of: grouping the transmission occasions of the set of transmission occasions according to a first grouping rule based at least in part on the gap being not larger than a gap threshold; or grouping the transmission occasions of the set of transmission occasions according to a second grouping rule based at least in part on the gap being larger than the gap threshold. The operations of 1004 may be performed in accordance with examples as described herein. In some implementations, aspects of the operations of 1004 may be performed by a device as described with reference to FIG. 1.

At 1006, the method may include transmitting an indication of one or more groups of the transmission occasions that comprise at least one unused transmission occasion. The operations of 1006 may be performed in accordance with examples as described herein. In some implementations, aspects of the operations of 1006 may be performed by a device as described with reference to FIG. 1.

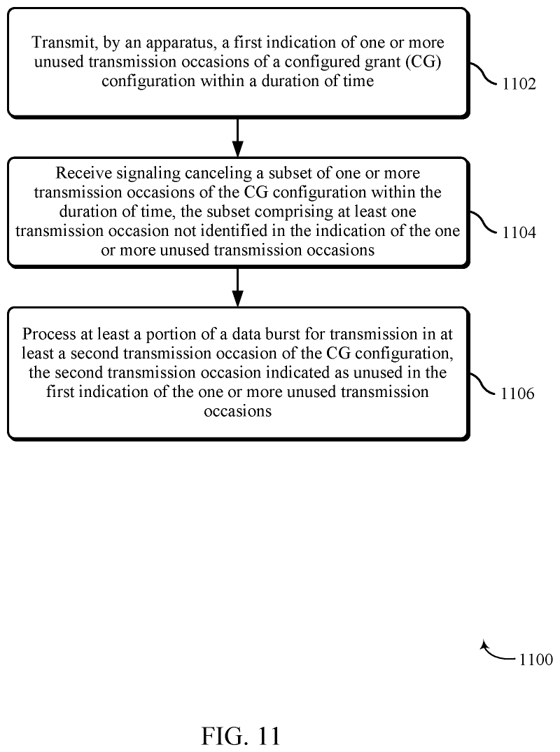

FIG. 11 illustrates a flowchart of a method 1100 that supports indication for unused transmission occasions for uplink cancellation in accordance with aspects of the present disclosure. The operations of the method 1100 may be implemented by a device or its components as described herein. For example, the operations of the method 1100 may be performed by a UE 104 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1102, the method may include transmitting, by an apparatus, a first indication of one or more unused transmission occasions of a CG configuration within a duration of time. The operations of 1102 may be performed in accordance with examples as described herein. In some implementations, aspects of the operations of 1102 may be performed by a device as described with reference to FIG. 1.

At 1104, the method may include receiving signaling canceling a subset of one or more transmission occasions of the CG configuration within the duration of time, the subset comprising at least one transmission occasion not identified in the indication of the one or more unused transmission occasions. The operations of 1104 may be performed in accordance with examples as described herein. In some implementations, aspects of the operations of 1104 may be performed by a device as described with reference to FIG. 1.

At 1106, the method may include processing at least a portion of a data burst for transmission in at least a second transmission occasion of the CG configuration, the second transmission occasion indicated as unused in the first indication of the one or more unused transmission occasions. The operations of 1106 may be performed in accordance with examples as described herein. In some implementations, aspects of the operations of 1106 may be performed by a device as described with reference to FIG. 1.

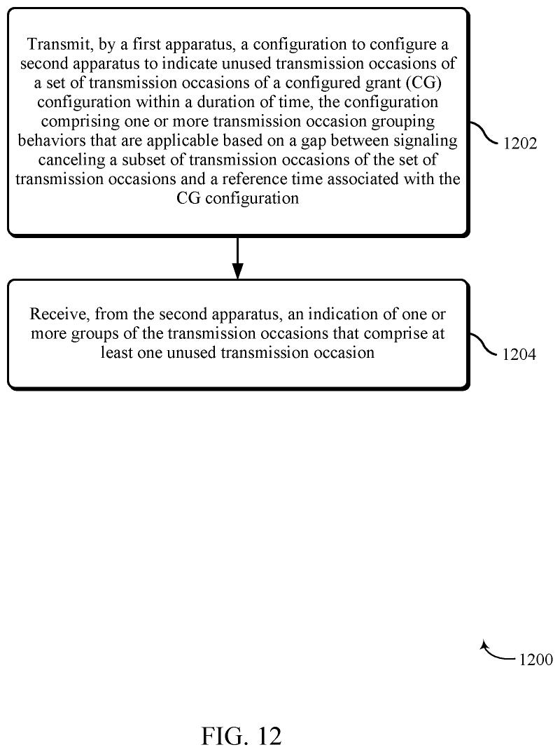

FIG. 12 illustrates a flowchart of a method 1200 that supports indication for unused transmission occasions for uplink cancellation in accordance with aspects of the present disclosure. The operations of the method 1200 may be implemented by a device or its components as described herein. For example, the operations of the method 1200 may be performed by a network entity 102 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1202, the method may include transmitting, by a first apparatus, a configuration to configure a second apparatus to indicate unused transmission occasions of a set of transmission occasions of a CG configuration within a duration of time, the configuration comprising one or more transmission occasion grouping behaviors that are applicable based on a gap between signaling canceling a subset of transmission occasions of the set of transmission occasions and a reference time associated with the CG configuration. The operations of 1202 may be performed in accordance with examples as described herein. In some implementations, aspects of the operations of 1202 may be performed by a device as described with reference to FIG. 1.

At 1204, the method may include receiving, from the second apparatus, an indication of one or more groups of the transmission occasions that comprise at least one unused transmission occasion. The operations of 1204 may be performed in accordance with examples as described herein. In some implementations, aspects of the operations of 1204 may be performed by a device as described with reference to FIG. 1.

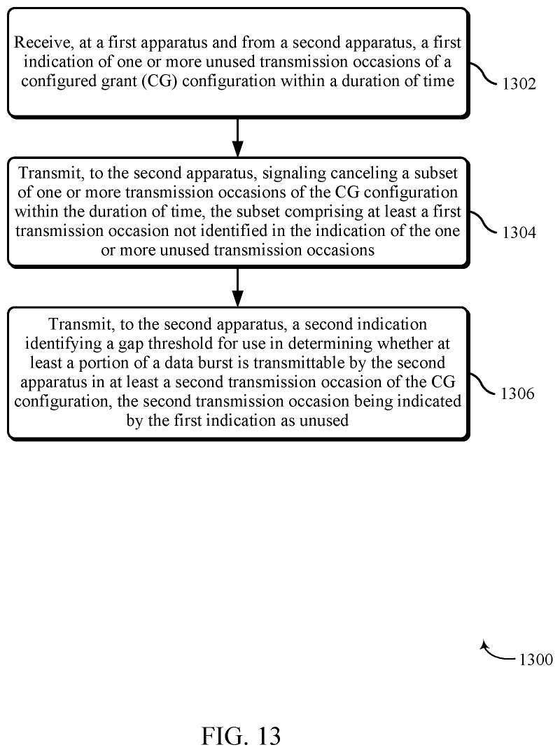

FIG. 13 illustrates a flowchart of a method 1300 that supports indication for unused transmission occasions for uplink cancellation in accordance with aspects of the present disclosure. The operations of the method 1300 may be implemented by a device or its components as described herein. For example, the operations of the method 1300 may be performed by a network entity 102 as described with reference to FIGS. 1 through 9. In some implementations, the device may execute a set of instructions to control the function elements of the device to perform the described functions. Additionally, or alternatively, the device may perform aspects of the described functions using special-purpose hardware.

At 1302, the method may include receiving, at a first apparatus and from a second apparatus, a first indication of one or more unused transmission occasions of a CG configuration within a duration of time. The operations of 1302 may be performed in accordance with examples as described herein. In some implementations, aspects of the operations of 1302 may be performed by a device as described with reference to FIG. 1.

At 1304, the method may include transmitting, to the second apparatus, signaling canceling a subset of one or more transmission occasions of the CG configuration within the duration of time, the subset comprising at least a first transmission occasion not identified in the indication of the one or more unused transmission occasions. The operations of 1304 may be performed in accordance with examples as described herein. In some implementations, aspects of the operations of 1304 may be performed by a device as described with reference to FIG. 1.

At 1306, the method may include transmitting, to the second apparatus, a second indication identifying a gap threshold for use in determining whether at least a portion of a data burst is transmittable by the second apparatus in at least a second transmission occasion of the CG configuration, the second transmission occasion being indicated by the first indication as unused. The operations of 1306 may be performed in accordance with examples as described herein. In some implementations, aspects of the operations of 1306 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive signaling canceling a subset of transmission occasions of a set of transmission occasions of a configured grant (CG) configuration;
group transmission occasions of the set of transmission occasions based on a gap between the received signaling and a reference time associated with the CG configuration, including one or more of to:
group the transmission occasions of the set of transmission occasions according to a first grouping rule based at least in part on the gap being not larger than a gap threshold; or
group the transmission occasions of the set of transmission occasions according to a second grouping rule based at least in part on the gap being larger than the gap threshold; and
transmit an indication of one or more groups of the transmission occasions that comprise at least one unused transmission occasion.

2. The UE of claim 1, wherein the set of transmission occasions are confined within a duration of time.

3. The UE of claim 2, wherein the at least one processor is operable to cause the UE to receive a configuration to configure the UE to indicate unused transmission occasions of the CG configuration within the duration of time.

4. The UE of claim 1, wherein to group the transmission occasions of the set of transmission occasions according to the first grouping rule, the at least one processor is operable to cause the UE to map the transmission occasions to different groups.

5. The UE of claim 1, wherein a number of transmission occasions in one or more groups associated with the second grouping rule is smaller than a number of transmission occasions in one or more groups associated with the first grouping rule.

6. The UE of claim 1, wherein to transmit the indication of one or more groups of the transmission occasions that comprise at least one unused transmission occasion, the at least one processor is operable to cause the UE to transmit the indication via uplink control information (UCI) within a duration of time.

7. The UE of claim 6, wherein the gap comprises a second duration of time based at least in part on a number of symbols between a last symbol of a control resource set (CORESET) comprising the signaling and a first symbol of the UCI.

8. The UE of claim 7, wherein the at least one processor is operable to cause the UE to determine a duration of the gap in the number of symbols based at least in part on a symbol duration according to a reference subcarrier spacing, and wherein the reference subcarrier spacing is a smallest subcarrier spacing between a subcarrier spacing configuration of physical downlink control channel (PDCCH) carrying the signaling and a smallest subcarrier spacing configuration provided for uplink (UL).

9. The UE of claim 1, wherein the reference time comprises at least one of:
a starting symbol of a first CG occasion of the CG configuration;
a last symbol of the first CG occasion of the CG configuration; or
a last symbol of uplink control information (UCI) used to transmit the indication of one or more groups of the transmission occasions that comprise at least one unused transmission occasion.

10. The UE of claim 1, wherein the set of transmission occasions are confined within a duration of time, and wherein the duration of time comprises an integer number of periods of the CG configuration.

11. The UE of claim 1, wherein the at least one processor is operable to cause the UE to determine the threshold gap based at least in part on one or more of higher layer signaling or an apparatus capability reporting signaling.

12. The UE of claim 1, wherein in an event that the gap is not larger than the threshold gap, to determine the one or more groups of the transmission occasions that comprise at least one unused transmission occasion, the at least one processor is operable to cause the UE to ignore the signaling.

13. The UE of claim 1, wherein the at least one processor is operable to cause the UE to:
determine a time domain window (TDW) over which power consistency and phase continuity are to be maintained across physical uplink shared channel (PUSCH) transmissions for demodulation reference signal (DMRS) bundling; and
indicate that one or more transmission occasions corresponding to the TDW are unused in an event that the one or more transmission occasions corresponding to the TDW comprising a DMRS symbol is indicated as unused.

14. The UE of claim 1, wherein each group of transmission occasions is associated with a codepoint in a bit-field in uplink control information (UCI), and wherein the bit-field indicates at most one group of transmission occasions as unused.

15. The UE of claim 1, wherein each group of transmission occasions is associated with a bit in a bit-field in uplink control information (UCI), and wherein the bit-field indicates the one or more groups of the transmission occasions that comprise at least one unused transmission occasion.

16. The UE of claim 1, wherein the signaling canceling the subset of transmission occasions of the set of transmission occasions comprises one or more of an uplink (UL) cancellation indication or a slot format indication (SFI), and wherein one or more of:
the UL cancellation indication cancels a transmission occasion in an event that a symbol of the transmission occasion is indicated by the UL cancellation indication as to be canceled; or
the SFI indicates one or more of a change of one or more of an UL symbol or a flexible symbol to a downlink (DL) symbol.

17. The UE of claim 1, wherein the at least one processor is operable to cause the UE to transmit the first indication via uplink control information (UCI), and receive the signaling canceling the subset of transmission occasions before transmission of the UCI.

18. (canceled)

19. A user equipment (UE) for wireless communication, comprising:
at least one memory; and
at least one processor coupled with the at least one memory and operable to cause the UE to:
transmit a first indication of one or more unused transmission occasions of a configured grant (CG) configuration within a duration of time;
receive signaling canceling a subset of one or more transmission occasions of the CG configuration within the duration of time, the subset comprising at least one transmission occasion not identified in the indication of the one or more unused transmission occasions; and
process at least a portion of a data burst for transmission in at least a second transmission occasion of the CG configuration, the second transmission occasion indicated as unused in the first indication of the one or more unused transmission occasions.

20. (canceled)

21. A method performed by a user equipment (UE), the method comprising:
receiving signaling canceling a subset of transmission occasions of a set of transmission occasions of a configured grant (CG) configuration;
grouping transmission occasions of the set of transmission occasions based on a gap between the received signaling and a reference time associated with the CG configuration, including one or more of to:
group the transmission occasions of the set of transmission occasions according to a first grouping rule based at least in part on the gap being not larger than a gap threshold; or
group the transmission occasions of the set of transmission occasions according to a second grouping rule based at least in part on the gap being larger than the gap threshold; and
transmitting an indication of one or more groups of the transmission occasions that comprise at least one unused transmission occasion.

22. A method performed by a user equipment (UE), the method comprising:
transmitting a first indication of one or more unused transmission occasions of a configured grant (CG) configuration within a duration of time;
receiving signaling canceling a subset of one or more transmission occasions of the CG configuration within the duration of time, the subset comprising at least one transmission occasion not identified in the indication of the one or more unused transmission occasions; and
processing at least a portion of a data burst for transmission in at least a second transmission occasion of the CG configuration, the second transmission occasion indicated as unused in the first indication of the one or more unused transmission occasions.
